(19) United States
(12) Patent Application Publication
(10) Pub. No.: US 2025/0172908 A1
(43) Pub. Date: May 29, 2025

(54) RATCHET FOR A CLOCKWORK MECHANISM

(71) Applicant: Rolex SA, Genève 26 (CH)

(72) Inventor: Olivier KARLEN, Blonay (CH)

(21) Appl. No.: 18/963,703

(22) Filed: Nov. 28, 2024

(30) Foreign Application Priority Data
Nov. 29, 2023 (EP) 23213123.5

(51) Int. Cl. G04B 11/02; G04B 3/00

(52) U.S. Cl. CPC G04B 11/024; G04B 3/00

(57) ABSTRACT

The invention relates to a click (10) for a mobile (5), of a timepiece mechanism, arranged to be movable between:
a blocking position, in which the click (10) blocks a movement of the mobile (5) in a first displacement direction (S1),
a release position, in which the click (10) allows a movement of the mobile (5) in a second displacement direction (S2),
the click (10) comprising an elastic section (4) arranged to exert a return force of the click (10) towards the blocking position,
characterised in that the elastic section (4) comprises a support portion (4.3) arranged to form, with a reference portion (6.1) of the timepiece mechanism, a stop interface in which the support portion (4.3) is at least partially enclosed in the reference portion (6.1), or in which the reference portion (6.1) is at least partially enclosed in the support portion (4.3).

### CROSS-REFERENCE TO RELATED APPLICATIONS

The present application claims priority to European Application No. 23213123.5 filed with the European Patent Office on Nov. 29, 2023 and entitled “RATCHET FOR A CLOCKWORK MECHANISM,” which is incorporated herein by reference in their entirety for all purposes.

### FIELD OF THE INVENTION

The present invention relates in general to timepiece mechanisms and, in particular, the present invention relates to clicks intended to interact with a mobile (typically a toothed wheel) in order to block a movement of the mobile in a first displacement direction, and to allow a movement of the mobile in a second displacement direction.

### PRIOR ART

It is known in the prior art to provide clicks with an elastic section intended to exert a return force of the click towards a blocking position of the click, wherein the click is arranged to block a movement of the mobile in a first displacement direction. Typically, this resilient portion cooperates with a support portion of the chassis or frame or mechanism (being part of a housing formed in the frame of the timepiece part) to exert the return force. However, there is a risk of the end of the elastic section disengaging from the support portion and/or from its housing, and the click will no longer be returned to its blocking position and will become inoperative. It can also be noted that the housing and/or the support section surrounds the click, which requires a significant dedicated space. Finally, it can be noted that the assembling of the click and of its associated mobile in a timepiece mechanism incorporating these parts can be delicate. More specifically, in particular when it involves screwing-blocking or unscrewing-unblocking the axis (generally screwed) of the mobile, the click only blocks one direction of rotation: at least one of the operations mentioned above (screwing-blocking or unscrewing-unblocking) requires an additional blocking of the mobile. This problem is typically encountered when the mobile is a barrel ratchet, mounted on a barrel arbour able to normally pivot freely in one direction or another.

### DISCLOSURE OF THE INVENTION

An aim of the present invention is to respond to the above-mentioned disadvantages of the prior art and, in particular, firstly to provide a click for a timepiece mechanism which has increased operating security or reliability, and/or which is compact, and/or which is easy to manufacture and/or which simplifies the assembling of the timepiece mechanism incorporating the click and its associated mobile.

For this purpose, a first aspect of the invention relates to a click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support portion.

According to the above implementation, the support portion is at least partially enclosed in the reference portion, or the reference portion is at least partially enclosed in the support portion, which guarantees a robust and reliable cooperation between the support portion and the reference portion. That is to say, this implementation overcomes the risks of having the support portion of the elastic section leave its housing, i.e. having the support portion disengage or lose all contact with the reference portion. More specifically, one of the support portion and the reference portion is enclosed or confined in the other of the support portion and the reference portion. In other words, the support portion is at least partially enclosed or surrounded or caged or inserted or introduced or bounded in the reference portion, or the reference portion is at least partially enclosed or surrounded or caged or inserted or introduced or bounded in the support portion.

The invention can be better defined by the following features, taken individually or in combination.

According to one embodiment, the stop interface has a clearance (typically an angular clearance) between the support portion and the reference portion, and during a part of the movement of the click between the blocking position and the release position, the support portion is freely displaced relative to the reference portion (typically, the support portion is freely displaced relative to the reference portion over at least 30%, at least 40%, at least 50%, at least 60% of the movement of the click between the blocking position and the release position). Such a clearance can offer a large displacement stroke to the click between the blocking position and the release position, without large or significant force to be applied. However, even with the above-cited clearance, the support portion is at least partially enclosed in the reference portion, or the reference portion is at least partially enclosed in the support portion. That is to say, one embodiment relates to a click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support,
wherein the stop interface has a clearance (typically an angular clearance) between the support portion and the reference portion, and during a part of the movement of the click between the blocking position and the release position, the support portion is freely displaced relative to the reference portion (typically, the support portion is freely displaced relative to the reference portion over at least 30%, at least 40%, at least 50%, at least 60% of the movement of the click between the blocking position and the release position).

According to one embodiment:
one of the support portion and the reference portion comprises a female shape,
the other of the support portion and of the reference portion comprises a male shape arranged to be received in the female shape.

According to one embodiment:
the support portion follows a displacement trajectory during the movement of the click between the blocking position and the release position,
the female shape has an elongate shape, preferably oblong shape, in the direction of the displacement trajectory. For example, the female shape can be a straight or curved oblong hole, as a function of the displacement trajectory of the support portion relative to the reference portion. That is to say, one embodiment relates to a click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support,
and wherein:
the support portion follows a displacement trajectory during the movement of the click between the blocking position and the release position,
the female shape is an elongate shape, preferably oblong shape, in the direction of the displacement trajectory.

According to one embodiment, the support portion is provided in a protrusion formed at a first end of the elastic section.

According to one embodiment, the click comprises a body formed integral or in one piece with the elastic section and the support portion.

According to one embodiment, the body comprises:
a bearing to enable a rotary movement of the click between the blocking position and the release position, and/or
a latching tongue, arranged to be engaged with the mobile when the click is in the blocking position, and/or
a blocking stop, arranged to be in abutment with a reference stop of the timepiece mechanism or with the mobile when the click is in the blocking position,
and the body is formed preferably integral or in one piece with the bearing and/or with the latching tongue and/or with the blocking stop. That is to say, one embodiment relates to a click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support,
and in which the body comprises:
a bearing to enable a rotary movement of the click between the blocking position and the release position, and/or
a latching tongue, arranged to be engaged with the mobile when the click is in the blocking position, and/or
a blocking stop, arranged to be in abutment with a reference stop of the timepiece mechanism or with the mobile when the click is in the blocking position, and the body is formed preferably integral or in one piece with the bearing and/or with the latching tongue and/or with the blocking stop.

According to one embodiment, the reference stop is formed by the reference portion. That is to say, it can be provided that the resilient portion of the click, and in particular the support portion of the click, cooperates, on the one hand, with the reference portion, and it can be provided that another portion of the click (the blocking stop) cooperates, on the other hand, with the reference portion (which then forms the reference stop) in order to define the blocking position. It is possible to provide, for example, the blocking stop and the support portion on different levels or altitudes of the click.

According to one embodiment, the elastic section is formed by a spring arm, arranged to be preferably actuated substantially in traction and/or in flexion. According to one embodiment the spring arm can be curved such that the spring arm is substantially stressed and/or deformed in flexion. The spring arm can have a variable cross-section along the spring arm.

According to one embodiment, the click is arranged to be displaced into an immobilisation position, different from the blocking position and the release position, and the click, in the immobilisation position, is arranged to block the mobile at least in the second displacement direction. That is to say, the click is intended to be able to be placed in an immobilisation position in order to block the mobile in the second displacement direction, in order to enable an assembly or disassembly operation of the mobile for example. The immobilisation position is a third working position of the click, different from the blocking position and the release position, which are the positions usually occupied by a click in order to form a non-return element to the mobile in the first displacement direction while allowing a movement in the second displacement direction. The click can be typically displaced towards the immobilisation position by a manual operation carried out by an assembly or maintenance operator. That is to say, one embodiment relates to a click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support,
and wherein the click is arranged to be displaced into an immobilisation position, different from the blocking position and the release position, and the click, in the immobilisation position, is arranged to block the mobile at least in the second displacement direction.

According to one embodiment, the click is arranged to block the mobile in the first displacement direction, when the click is configured in the immobilisation position. Thus, in the immobilisation position, the mobile and the remainder of the timepiece mechanism kinematically linked thereto are blocked and cannot move (by pivoting for example) in the second (normally free) displacement direction and preferably in no displacement direction (neither the first displacement direction, nor the second displacement direction). Once the click is in the immobilisation position, an assembly or disassembly operation of the mobile is possible without simultaneous action on the click.

According to an embodiment, the click comprises a stop portion arranged to be engaged with the mobile in order to block it at least in the second displacement direction, and preferably in the first displacement direction, when the click is configured in the immobilisation position. The stop portion can be a protuberance, an index or a male shape arranged to be supported on the mobile (for example on two teeth of the mobile).

According to one embodiment, when the click is in the immobilisation position, the stop portion is arranged at least between two adjacent teeth of the mobile. Alternatively, the stop portion can be formed by two teeth on the click provided to engage between three adjacent teeth of the mobile.

According to one embodiment, the click comprises an immobilisation portion, arranged to impose and maintain the immobilisation position of the click, for example in cooperation with an immobilisation stop of the timepiece mechanism. The immobilisation portion can be a notch or a notching.

According to one embodiment, the immobilisation portion comprises a resilient return section. The immobilisation portion can be a resilient notch or a resilient notching.

According to one embodiment, the immobilisation portion comprises a protuberance, preferably a radial protuberance, arranged to form an obstacle to the displacement of the click from the immobilisation position towards the blocking position or the release position. The protuberance can be a notch, a beak, an index or a tooth, provided to cooperate with a counter shape provided on the chassis or the frame of the timepiece part (the counter-shape can be an index or a projection provided on the frame of the timepiece part, for example a pin, a gorge, a groove or any other shape able to retain the radial protuberance of the click). According to one embodiment, the counter-shape can be the reference stop.

A second aspect of the invention relates to a click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
characterised in that the click is arranged to be displaced into an immobilisation position, different from the blocking position and the release position, in which the click is arranged to block the mobile in the second displacement direction. That is to say, the click is intended to be able to be placed in an immobilisation position in order to block the mobile in the second displacement direction, in order to allow an assembly and disassembly operation of the mobile for example. The immobilisation position is a third working position of the click, different from the blocking position and the release position, which are the positions usually occupied by a click in order to form a non-return element to the mobile in the first displacement direction while allowing a movement in the second displacement direction. The click can be typically displaced towards the immobilisation position by a manual operation of an assembly or maintenance operator.

According to one embodiment, the click is arranged to block the mobile in the first displacement direction, when the click is configured in the immobilisation position. Thus, in the immobilisation position, the mobile and the remainder of the timepiece mechanism kinematically linked thereto are blocked and cannot move (by pivoting for example) in the second (normally free) displacement direction and preferably in no displacement direction (neither the first displacement direction, nor the second displacement direction). Once the click is in the immobilisation position, an assembly or disassembly operation of the mobile is possible without simultaneous action on the click.

According to an embodiment, the click comprises a stop portion arranged to be engaged with the mobile in order to block it at least in the second displacement direction, and preferably in the first displacement direction, when the click is configured in the immobilisation position. The stop portion can be a protuberance, an index or a male shape arranged to be supported on the mobile (for example on two teeth of the mobile).

According to one embodiment, when the click is in the immobilisation position, the stop portion is arranged at least between two adjacent teeth of the mobile.

According to one embodiment, the click comprises an immobilisation portion, arranged to impose and maintain the immobilisation position of the click, for example in cooperation with an immobilisation stop of the timepiece mechanism. The immobilisation portion can be a notch or a notching.

According to one embodiment, the reference stop is coincident with the immobilisation stop. That is to say, the immobilisation stop is formed by the reference stop.

According to one embodiment, the immobilisation portion comprises a protuberance, preferably a radial protuberance, arranged to form an obstacle to the displacement of the click from the immobilisation position towards the blocking position or the release position. The protuberance can be a notch, a beak, an index or a tooth, provided to cooperate with a counter shape provided on the frame of the timepiece part (the counter-shape can be an index or a projection provided on the frame of the timepiece part, for example a pin, a gorge, a groove or any other shape able to retain the radial protuberance of the click). According to one embodiment, the counter-shape can be the reference stop.

According to one embodiment, the immobilisation portion comprises a resilient return section.

According to one embodiment, the click comprises a recess arranged between the immobilisation portion and the remainder of the click. Such a recess (a slot) forms at least one flexible beam between the click and the immobilisation portion.

According to one embodiment, the reference stop is embedded or formed directly on the click. That is to say, the reference stop is a portion embedded or formed directly on the click. According to one embodiment, the reference stop embedded on the click is intended to cooperate with the toothed mobile or with a portion of the frame, such as the reference portion. According to one embodiment, the reference stop embedded on the click is arranged on a different level from a level of the support portion. According to one embodiment, the reference stop embedded on the click is intended to engage between two teeth of the toothed mobile.

In general, according to one embodiment, the click is made of metal alloy comprising nickel and phosphorus. According to one embodiment, the click is produced by electrodeposition, according to a lithography, electroplating and moulding method (LIGA). According to one embodiment, the click is produced by microetching of a silicon support, preferably by a DRIE method. According to one embodiment, the click is produced by moulding. According to one embodiment, the click is made of metal alloy that is insensitive to magnetic fields. According to one embodiment, the click is made of amorphous metal alloy. According to one embodiment, the click is monolithic or in one piece.

A third aspect of the invention relates to a timepiece assembly, comprising at least one click according to the first aspect or according to the second aspect, and at least the reference portion of the timepiece mechanism.

According to one embodiment, the timepiece assembly comprises the mobile, for example a ratchet wheel or a ratchet.

A fourth aspect of the invention relates to a timepiece part, comprising at least one click according to the first aspect.

### DESCRIPTION OF THE FIGURES

Other features and advantages of the present invention will become more clearly apparent on reading the following detailed description of an embodiment of the invention, given by way of not-limiting example, and illustrated by the appended drawings, in which:

FIG. 1 shows a view of a click according to the invention, incorporated in a timepiece mechanism further comprising a mobile, the click of FIG. 1 occupying a blocking position in which the click is arranged to block a movement of the mobile in a first displacement direction;

FIG. 2 shows the click of FIG. 1, occupying a release position, in which the click is arranged to allow a movement of the mobile in a second displacement direction;

FIG. 3 shows the click of FIG. 1, occupying an immobilisation position in which the click is arranged to block the mobile, at least in the second displacement direction.

### DETAILED DESCRIPTION OF EMBODIMENTS

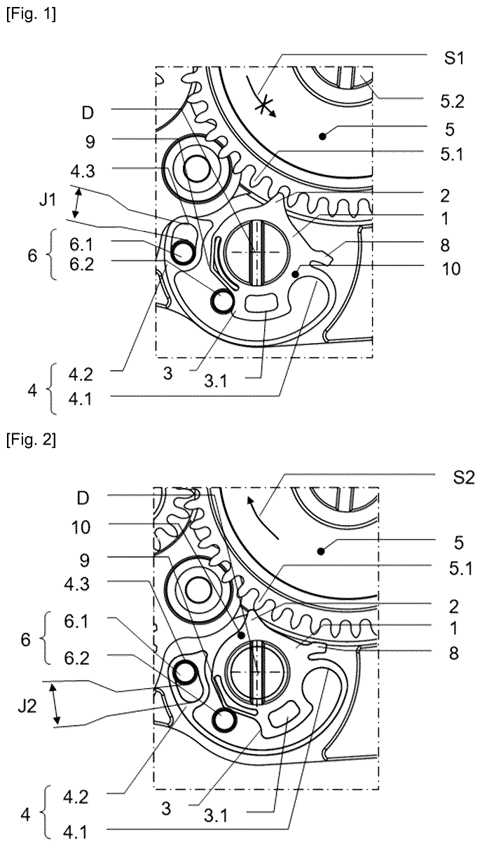

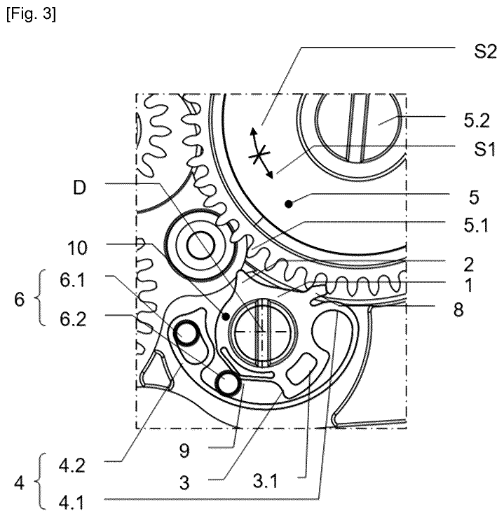

FIGS. 1 to 3 show a view from above of a section of a timepiece mechanism, with a click 10 according to the invention, engaged in various manners with a mobile 5. FIG. 1 shows the click 10 in a blocking (or non-return) position of the mobile 5, FIG. 2 shows the click 10 in a release position of the mobile 5 and FIG. 3 shows the click 10 in a total immobilisation position of the mobile 5.

In this example, the mobile 5 is a ratchet mounted on a barrel and FIGS. 1 to 3 are partial views to clearly show the click 10 and a section of the mobile 5, in this case the ratchet. FIGS. 1 to 3 are therefore partial face views of a barrel bridge forming, more generally, a section of a frame 6 of the timepiece part.

In detail, the frame 6 (in this case the barrel bridge) comprises a reference portion 6.1 formed by a first pin and a reference stop 6.2 formed by a second pin. The mobile 5 is typically fixed on a barrel arbour by a screw 5.2, and comprises ratchet teeth 5.1 arranged to cooperate with the click 10.

The click 10 comprises, in particular:
a hub 1, preferably pivoting around a portion of the frame 6 along an axis D and axially held by screw or a threaded arbour for example,
a latching tongue 2, arranged on the periphery of the hub 1,
a stop portion 8, arranged on the periphery of the hub 1 and next to the latching tongue 2,
a resilient portion 4, forming a spring arm, and comprising a first end 4.1, connected to the hub 1, adjacent to or beside the stop portion, and a second end 4.2 defining a support portion 4.3 formed by an inner surface of a female oblong shape which preferably extends along a trajectory that is ortho-radial or tangential or substantially ortho-radial or substantially tangential relative to a radius passing through the axis D,
a blocking stop 3, arranged at the periphery of the hub 1 and adjacent to or beside the first end 4.1,
an immobilisation portion 9, arranged at the periphery of the hub 1 and adjacent to or beside the blocking stop 3. The immobilisation portion 9 is substantially formed by a radial protuberance separated from the hub 1 by a slot, although a resilient displacement of the immobilisation portion 9 relative to the hub 1 (and/or the remainder of the click 10) is possible in a radial or substantially radial direction of the click 10 relative to a radius passing through the axis D.

The click 10 is a monolithic part or in one piece. A substantially flat part can be provided, for example manufactured by additive technology, for example by electrodeposition in a mould manufactured by lithography, or by microfabrication such as etching in a silicon wafer, or by moulding. The click 10 can be metallic (for example electrodeposited nickel and phosphorus-based metal alloy), semiconducting (such as silicon) or insulating (such as a ceramic).

The various points below can be noted in FIG. 1:
the second end 4.2 encloses the reference portion 6.1. More specifically, a protrusion formed at the second end 4.2 enables an oblong female shape to be formed, having an inner surface defining a support portion 4.3.
a clearance J1 in FIG. 1, in this case an angular clearance in an ortho-radial or tangential direction relative to a radius passing through the axis D, is present between the reference portion 6.1 and the support portion 4.3.
the click 10 is in abutment against the frame 6, because a contact can be noted between the blocking stop 3 and the reference stop 6.2 of the frame 6.
the immobilisation portion 9 is totally disengaged from the reference stop 6.2.
the blocking stop 3 has a through-hole 3.1 which can allow a watchmaker to manipulate and/or grasp the click 10 with, for example, a pin or tweezers.

In FIG. 1, the click 10 occupies a blocking position in which the click 10 is arranged to block a movement of the mobile 5 in a first displacement direction S1. More specifically, the latching tongue 2 is engaged between two teeth 5.1 of the mobile 5 and the blocking stop 3 is supported on the reference stop 6.2 of the frame 6. Thus, and as shown by the crossed-out arrow of FIG. 1, any movement of the mobile 5 in the first displacement direction S1 is blocked by the click 10. It can be seen that the blocking stop 3 can be arranged differently and could come into abutment with a portion of the mobile 5, for example by taking the form of a simple tongue which can come into abutment on or between the teeth 5.1 of the mobile 5.

FIG. 2 shows the click 10 of FIG. 1, occupying a release position, in which the click 10 is arranged to allow a movement of the mobile 5 in a second displacement direction S2. More specifically, as indicated above, the click 10 is mounted in pivoting connection on the frame 6. Thus, during a movement of the mobile 5 in the second direction S2 as in FIG. 2, the click 10 can pivot in the anticlockwise direction in order to occupy the release position shown in FIG. 2 under the action of a force applied by a tooth 5.1 on the latching tongue 2.

During the displacement of the click 10 towards the release position:
the blocking stop 3 leaves or loses its support on the reference stop 6.2 of the frame 6,
the second end 4.2 slides on the reference portion 6.1 in order that the upper section of the support portion 4.3 comes into contact on the reference portion 6.1 so as to create a clearance J2 below the reference portion 6.1. During this sliding of the reference portion 6.1 in the second end 4.2, the click 10 is displaced without significant force, which enables a smooth operation to be provided with a minimum of force, so as to minimise the torque required for displacing the click 10.
the resilient portion 4 is resiliently deformed, substantially in flexion according to this construction example (but other types or configurations of tensioning of the resilient portion 4 are possible, such as traction, torsion, compression or any combination of these types of stresses), so as to create a return force of the click 10 towards the blocking position of FIG. 1,
the immobilisation portion 9, due to the anti-clockwise pivoting of the click 10, has approached the reference stop 6.2, without however significantly interacting. However, it is possible to provide a contact between the immobilisation portion 9 and the reference stop 6.2, in order to limit, for example, any overtravel of the click 10 in the anticlockwise direction.

During the rotation of the mobile 5 in the second displacement direction S2, each tooth 5.1 slides on the latching tongue 2 and is freely disengaged due to the resilient effect provided by the resilient portion 4. If, by contrast, the mobile 5 is immobilised or is displaced in the first displacement direction S1, then the effect of the tension of the resilient portion 4 and/or the cooperation of the latching tongue 2 with the teeth 5.1 where applicable, causes a return of the click 10 into the blocking position of FIG. 1.

Thus, if the mobile 5 is a ratchet for a barrel, it is possible to tension or arm the barrel spring during the displacement in the second direction of rotation S2 (configuration of FIG. 2), and this tension or this arming is perfectly guaranteed and maintained by the click 10 when it returns to its blocking position (configuration of FIG. 1).

It can be noted that the displacement of the click 10 between the blocking position and the release position is made without involvement by the resilient portion 4, due to the clearance provided between the reference portion 6.1 and the support portion 4.3. As can be seen in FIGS. 1 and 2, the clearance in question is substantially normal to a radius passing through the axis D. In order to effectively limit the forces to be implemented in order to displace the click 10, the clearance in question represents at least 40% and even at least 50% of the displacement of the click 10 between the blocking position and the release position. That is to say, at least 40% and even at least 50% of the displacement of the click 10 between the blocking position and the release position takes place without action on the resilient portion 4 (arming or relaxing).

FIG. 3 shows the click 10 of FIG. 1, occupying an immobilisation position in which the click 10 is arranged to block the mobile at least in the second displacement direction S2. More specifically, in order to facilitate, for example, an assembly or disassembly operation of the mobile 5 (in this case a barrel ratchet), it is made possible to block the displacement of the mobile at least in the second displacement direction S2 (normally free, in the typical and conventional operation of the click 10 described in FIGS. 1 and 2).

For this purpose, in order to block the mobile 5 at least in the second displacement direction S2 (and, in this example, also in the first displacement direction S1), it is made possible to displace the click 10 in a third position, different from the blocking position of FIG. 1 and the release position of FIG. 2, in order that the click 10 occupies an immobilisation position, as shown in FIG. 3. By inserting a tool, such as tweezers or a pin, in the hole 3.1 of the blocking stop 3 for example, a watchmaker can manually force the click 10 to pivot further in the anticlockwise direction relative to FIG. 2, in order that the immobilisation portion exceeds or passes beyond the reference stop 6.2 of the frame 6. In this immobilisation position, the reference stop 6.2 acts as immobilisation stop.

Such a movement is possible due to the capacity of the immobilisation portion 9 to be resiliently displaced relative to the hub 1, and the anticlockwise pivoting movement of the click 10 causes the insertion of the stop portion 8 between two teeth 5.1 of the mobile 5 to be simultaneously supported on these two teeth 5.1. In this example, the immobilisation portion 9 equates to a resilient notch which locks the click 10 in the immobilisation position of FIG. 3.

It can be noted that, in the immobilisation position and according to the exemplary embodiment of FIG. 3, the stop portion 8 is substantially stressed in compression and buttresses with the teeth 5.1 of the mobile 5. It can also be noted that in this configuration of FIG. 3, the resilient portion 4 is further resiliently deformed (relative to FIG. 2), but in any event the immobilisation portion 9 is arranged to exert a retaining force greater than the resilient force generated by the stress of the resilient portion 4.

Once the click 10 is in the immobilisation position of FIG. 3, a watchmaker can impose a torque, for example a tightening torque, in order to screw the screw 5.2 of the ratchet in the second displacement direction S2, the stop portion 8 preventing the movement of the mobile 5 and thus of the barrel arbour (typically coupled with the mobile 5 via a non-cylindrical hole, such as a square hole). It can be noted in FIG. 3 that the stop portion 8 is arranged to come into contact and/or to buttress with two teeth 5.1 of the mobile 5 so as to reliably block the movement of the mobile 5 and so that a tightening torque applied to the screw 5.2 in the second displacement direction S2 generates, on the click 10, a force which tends to pivot it further in the anticlockwise direction.

A torque, for example a loosening torque, applied to the screw 5.2 in the first displacement direction S1 generates, on the click 10, a force which tends to pivot it in the clockwise direction. Such a torque in the first displacement direction S1 can be applied without causing the movement of the click 10, as long as the immobilisation portion 9 can resist the sum of the return force of the resilient portion 4 and the force applied to the click 10 by this torque in the first displacement direction S1.

A displacement of the click 10 in the clockwise direction from the immobilisation position is caused either by the application on the mobile 5 or its screw 5.2 of a sufficiently large torque in the first displacement direction S1, or by applying a force to the click 10, for example with a tool introduced in the hole of the blocking stop 3. The movement in the clockwise direction has the effect of making the immobilisation portion 9 pass back onto or beyond the reference stop 6.2 (which thus forms an immobilisation stop here), and the click 10, at least under the effect of the return force of the still tensioned resilient portion 4, returns to the release position of FIG. 2 or to the blocking position of FIG. 1. It can be noted that, in the blocking position of FIG. 1, a watchmaker can exert a larger torque, on the mobile 5 or on the screw 5.2, in the first displacement direction S1 than when the click 10 is in the immobilisation position of FIG. 3. More specifically, in the blocking position of FIG. 1, the click 10 is in abutment against the reference stop 6.2 which forms a clear and robust obstacle.

It can be noted that the support portion 4.3 encloses the reference portion 6.1, so that even during significant travel of the click 10 between the blocking position and the immobilisation position, the risk of seeing the support portion 4.3 come out of the reference portion 6.1 (or vice versa) is removed, so that operational security is improved.

It can also be noted that the immobilisation position offered by the click 10 provides a notable simplification of the assembling of the mobile 5, in particular when it involves a mobile that is able to freely pivot in two directions of rotation, as is the case for a barrel ratchet.

Finally, it can be noted that the support portion 4.3 is a closed shape (in particular free of open hooks), which significantly limits the risk of entanglement or tangling during bulk polishing.

### INDUSTRIAL APPLICABILITY

A click for a timepiece mechanism according to the present invention, and its manufacture, are industrially applicable.

It is understood that various modifications and/or improvements that are obvious to a person skilled in the art can be applied to the various embodiments of the invention described in the present description, without going beyond the scope of the invention.

In particular, the support portion 4.3 of the click 10 can be a male shape which is enclosed or received in the reference portion 6.1, which would then have a female shape.

The support portion 4.3 of the click 10 can be at least partially enclosed or surrounded or caged or inserted or introduced or bounded in the reference portion 6.1. In the example shown, the support portion 4.3 is formed by a closed oblong shape which totally surrounds the reference portion 6.1, but an open or partially open perimeter can be provided, and preferably the opening has a size smaller than the size of the reference portion 6.1 (the diameter of the first pin in this example). Thus, even with an open shape, the reference portion 6.1 cannot pass through the opening.

1. A click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support portion.

2. The click according to claim 1, wherein the stop interface has a clearance between the support portion and the reference portion, such that during part of the movement of the click between the blocking position and the release position, the support portion moves freely relative to the reference portion.

3. The click according to claim 1, wherein:
one of the support portion and the reference portion comprises a female shape,
the other of the support portion and the reference portion comprises a male shape arranged to be received in the female shape.

4. The click according to claim 3, wherein:
the support portion follows a displacement trajectory during the movement of the click between the blocking position and the release position,
the female shape is an elongate shape, preferably an oblong shape, in the direction of the displacement trajectory.

5. The click according to claim 1, wherein the support portion is provided in a protrusion formed at a first end of the elastic section,
the click comprising a body formed in one piece with the elastic section and the support portion.

6. The click according to claim 5, wherein the body comprises:
a bearing to enable a rotary movement of the click between the blocking position and the release position, and/or
a latching tongue, arranged to be engaged with the mobile when the click is in the blocking position, and/or
a blocking stop, arranged to be in abutment with a reference stop of the timepiece mechanism or with the mobile when the click is in the blocking position, wherein the body is preferably formed in one piece with the bearing and/or with the latching tongue and/or with the blocking stop.

7. The click according to claim 1, wherein the elastic section is formed by a spring arm, arranged to be actuated substantially in traction and/or stressed in flexion.

8. The click according to claim 1, arranged to be displaced into an immobilisation position, different from the blocking position and the release position, in which the click is arranged to block the mobile at least in the second displacement direction.

9. The click according to claim 8, arranged to block the mobile in the first displacement direction, when the click is configured in the immobilisation position.

10. The click according to claim 8, comprising a stop portion arranged to be engaged with the mobile in order to block it at least in the second displacement direction, and preferably in the first displacement direction, when the click is configured in the immobilisation position,
wherein the stop portion, when the click is in the immobilisation position, is arranged at least between two adjacent teeth of the mobile.

11. The click according to claim 8, comprising an immobilisation portion, arranged to impose and maintain the immobilisation position of the click, for example in cooperation with an immobilisation stop of the timepiece mechanism.

12. The click according to claim 11, wherein the immobilisation portion comprises a resilient return section.

13. The click according to claim 11, wherein the immobilisation portion comprises a protuberance, preferably a radial protuberance, arranged to form an obstacle to the displacement of the click from the immobilisation position to the blocking position or the release position.

14. A click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support portion,
the click comprising a body comprising:
a bearing to enable a rotary movement of the click between the blocking position and the release position, and/or
a latching tongue, arranged to be engaged with the mobile when the click is in the blocking position, and/or
a blocking stop, arranged to be in abutment with a reference stop of the timepiece mechanism or with the mobile when the click is in the blocking position.

15. The click according to claim 14, wherein the body is formed in one piece with the bearing and/or with the latching tongue and/or with the blocking stop, and/or with the elastic section comprising the support portion provided in a protrusion formed at a first end of the elastic section.

16. A click for a mobile, for example a toothed mobile, of a timepiece mechanism, arranged to be mobile between:
a blocking position, in which the click is arranged to block a movement of the mobile in a first displacement direction,
a release position, in which the click is arranged to allow a movement of the mobile in a second displacement direction,
the click comprising an elastic section arranged to exert a return force of the click towards the blocking position,
characterised in that the elastic section comprises a support portion arranged to form, with a reference portion of the timepiece mechanism, a stop interface in which the support portion is at least partially enclosed in the reference portion, or in which the reference portion is at least partially enclosed in the support portion,
the click being arranged to be displaced into an immobilisation position, different from the blocking position and the release position, in which the click is arranged to block the mobile at least in the second displacement direction.

17. The click according to claim 16, comprising a stop portion arranged to be engaged with the mobile in order to block it at least in the second displacement direction, when the click is configured in the immobilisation position.

18. A timepiece assembly, comprising at least one click according to claim 1 and at least the reference portion of the timepiece mechanism.

19. The timepiece assembly according to claim 18, comprising the mobile, for example a ratchet wheel.

20. A timepiece, comprising at least one click according to claim 1.
